(19) United States
(12) Patent Application Publication
(10) Pub. No.: US 2017/0039791 A1
(43) Pub. Date: Feb. 9, 2017

(54) SYSTEM AND METHOD FOR PROTECTING LUGGAGE

(71) Applicants: EITAN HAYUN, KIRYAT ONO (IL); ELIYAHU BARUCH, RISHON LE ZION (IL)

(72) Inventors: ELIYAHU BARUCH, RISHON LE ZION (IL); EITAN HAYUN, KIRYAT ONO (IL); SAGI YOSEF BARZILAY, PETACH TIKVA (IL)

(21) Appl. No.: 14/957,678

(22) Filed: Dec. 3, 2015

(30) Foreign Application Priority Data
Aug. 3, 2015 (IL) 240317

(51) Int. Cl. G07C 9/00

(52) U.S. Cl. CPC G07C 9/00309

(57) ABSTRACT

A system for protecting a luggage, including a first device, for being carried by an owner of the luggage, the first device including a first code; a second device, for being physically attached to the luggage, the second device including a second code being compatible with the first code; and a detector, for allowing taking the luggage out of a physical site, upon verifying proximity of the first and second devices, and upon verifying the compatibility of the codes, thereby requiring proximity of the luggage to the owner for the taking luggage out of the physical site.

### FIELD

The invention relates to the field of airport managing. More particularly, the invention relates to a method and apparatus for protecting a luggage, during airport procedures.

### BACKGROUND

Conventionally, a sticker is stuck to a luggage for identifying it, and the luggage is protected from theft and from replacement, manually only.

Thus, there is a long felt need to protect the luggage by technological means.

In one aspect of the invention, the invention provides a method and apparatus for protecting the luggage by technological means.

In one aspect of the invention, the invention provides a solution to the above-mentioned and other problems of the prior art.

### SUMMARY

Thus, in one aspect, the invention is directed to a system for protecting a luggage, including:

a first device, for being carried by an owner of the luggage, the first device including a first code;

a second device, for being physically attached to the luggage, the second device including a second code being compatible with the first code; and

a detector, for allowing taking the luggage out of a physical site,
upon verifying proximity of the first and second devices, and
upon verifying the compatibility of the codes,

thereby requiring proximity of the luggage to the owner for the taking luggage out of the physical site.

### BRIEF DESCRIPTION OF THE DRAWINGS

Embodiments, features, and aspects of the invention are described herein in conjunction with the following drawings:

FIG. 1 depicts the first step of using the luggage protecting means, according to one embodiment of the invention.

FIG. 2 depicts the electronic circuit of the second device and the strap of FIG. 1.

FIG. 3 depicts the second step of using the protecting kit of FIG. 1.

FIG. 4 depicts the fourth step, of allowing the owner taking the luggage out of the airport.

FIG. 5 depicts means for protecting the luggage while being located within the airport.

The drawings are not necessarily drawn to scale.

### DETAILED DESCRIPTION

The invention will be understood from the following detailed description of embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

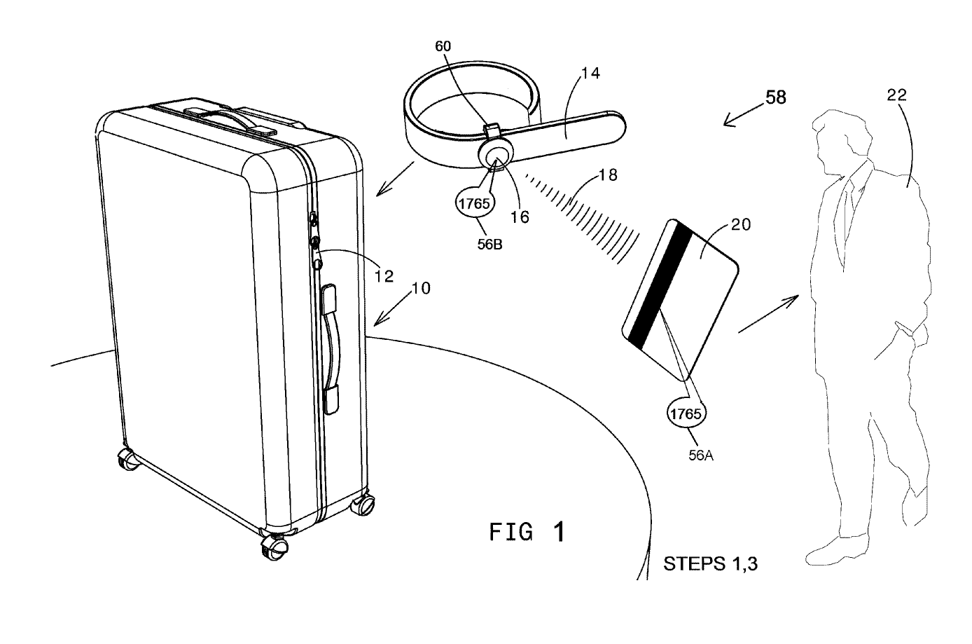

FIG. 1 depicts the first step of using the luggage protecting means, according to one embodiment of the invention.

At the first step, a luggage owner 22 receives a protecting kit 58, including a first device 20, a second device 16, and a strap 14.

Devices 20 and 16 are compatible, for instance device 20 has a code 56A and device 16 has a code 56B, and codes 56A and 56B are equal, e.g., 1765.

Device 16 includes a transmitter 60, for wirelessly verifying that code 56B indeed is compatible with code 56A.

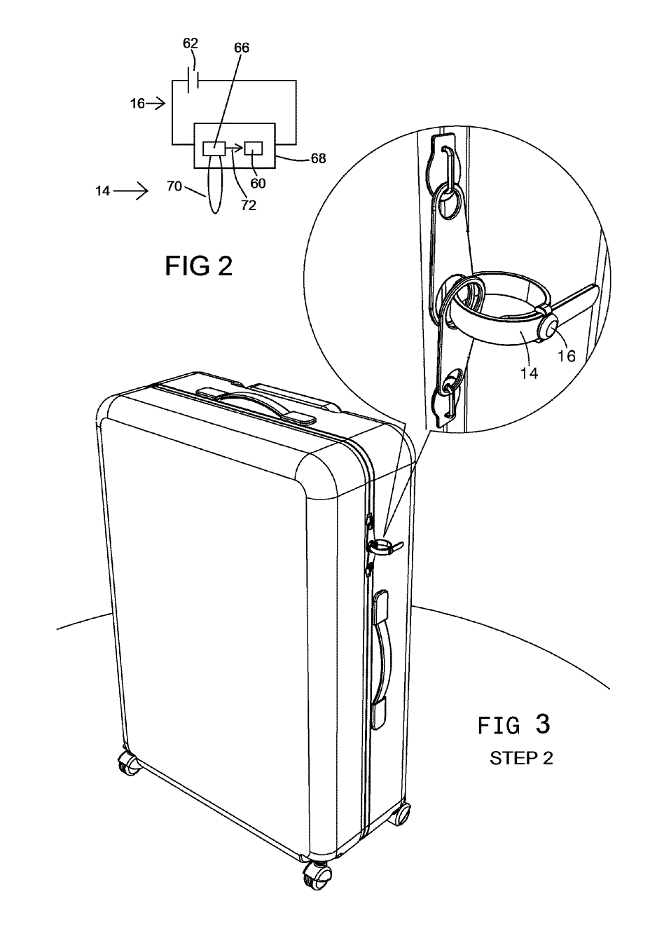

FIG. 2 depicts the electronic circuit of the second device and the strap of FIG. 1.

Device 16 includes a battery 62, for powering a circuitry 68. Circuitry 68 includes at least transmitter 60 and an alerting circuit 66, from which at least one electric wire 70 of strap 14 extends for closing the circuit, for operating transmitter 60, as depicted by arrow 72, for operating alert 26, once the circuit is cut.

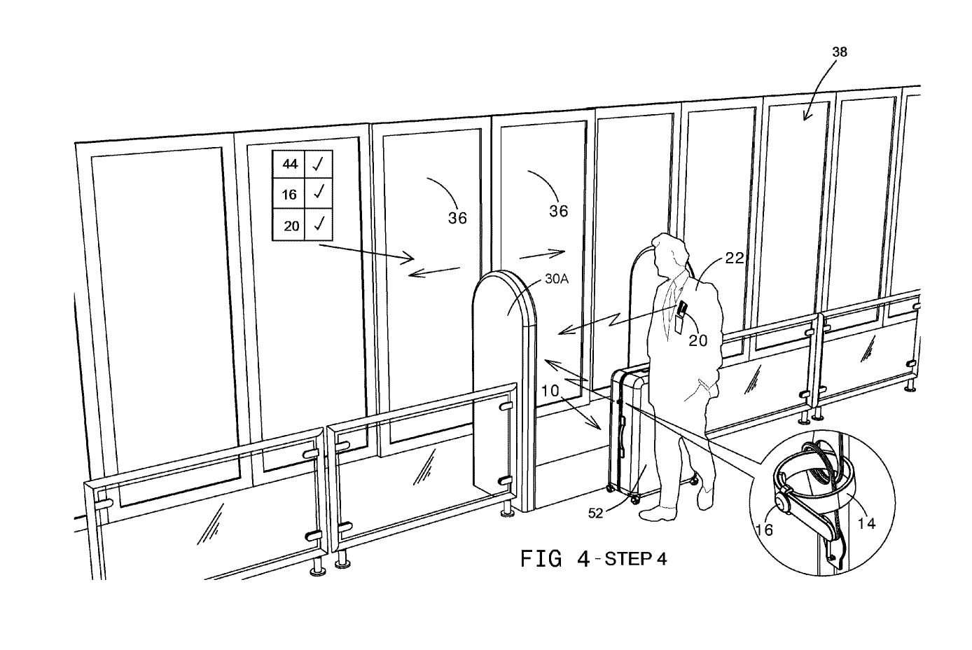

FIG. 3 depicts the second step of using the protecting kit of FIG. 1.

At the second step, luggage owner 22 attaches strap 14 to luggage 12, preferably in a manner not allowing opening the cover of the luggage without tearing strap 14. Strap 14 can be opened by tearing only.

Owner 22 may then depart from luggage 12.

Referring again to FIG. 1, at the third step, devices 16 and 20 accompany owner 22 in finding one another, by transferring a signal 18 therebetween.

FIG. 4 depicts the fourth step, of allowing the owner taking the luggage out of the airport.

Table 50 shows conditions, verified by a detector 30A, for allowing any person to take luggage 12 out of the airport 38, such as by opening doors 36 of airport 38.

The logical conditions are that strap 14 has not been torn from luggage 12; further, that strap 14 carries device 16; and further, that device 20 is compatible with device 16, and is disposed near device 16.

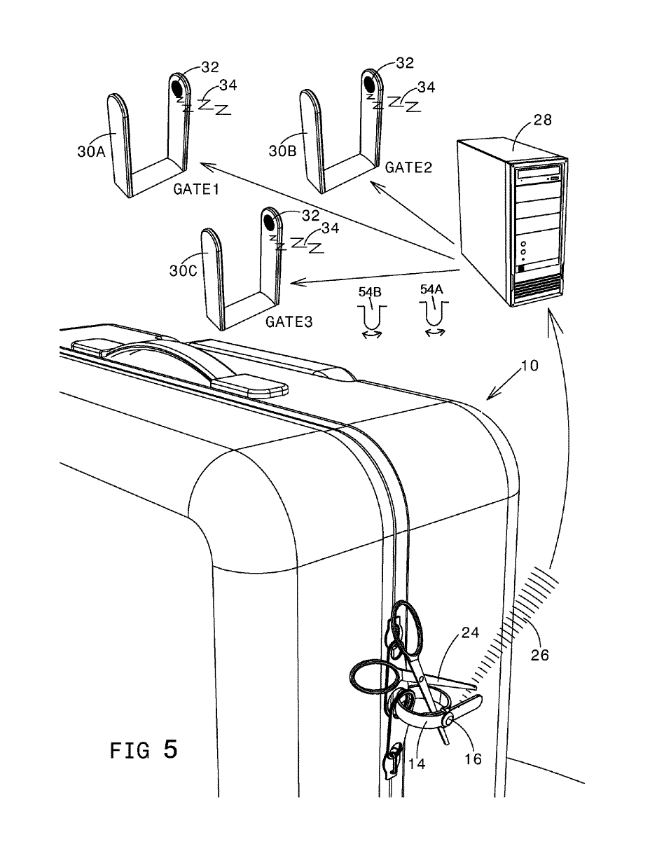

FIG. 5 depicts means for protecting the luggage while being located within the airport.

Luggage 12 is protected by device 16 identifying luggage 12. Device 16 is attached to luggage 12 in an irremovable manner.

The irremovable manner constitutes strap 14, which disallows removal of device 16 for further attaching thereof to another luggage without being noticed. For example, strap 14 can be opened by tearing thereof only.

The irremovable manner constitutes strap 14, which induces device 16 to alert upon tearing strap 14. The alert 26 is to be considered as stealing of luggage 12.

The alert 26 preferably may include the current location of device 16, transmitted thereby, and may attract cameras 54A and 54B to capture the reported location.

Alert 26 may further warn by speakers 32 of gateways 30A, 30B and 30C, regarding the luggage, even though the luggage no longer carries its identifying device 16.

Referring again to FIG. 4, in the normal case that no alert 26 has been initiated, detector 30A must practically verify only that the codes 56A and 56B of devices 16 and 20 are compatible, and that the devices are disposed nearby.

Thus, in one aspect, the invention is directed to a system (10) for protecting a luggage (12), including:
a first device (20), for being carried by an owner (22) of the luggage (12), the first device including a first code (56A);
a second device (16), for being physically attached to the luggage (12), the second device (16) including a second code (56B) being compatible with the first code (56A); and
a detector (30A), for allowing taking the luggage (12) out of a physical site (38),

upon verifying proximity of the first (20) and second (16) devices, and

upon verifying the compatibility of the codes (56A, 56B),

thereby requiring proximity of the luggage (12) to the owner (22) for the taking luggage (12) out of the physical site (38).

The system may further include:
a strap (14),

for making the physical attachment of the second device (16) to the luggage (12), and

for constructing an electric connection (70) upon the physical attachment, for inducing the second device (16) to alert (26) upon cutting the electric connection (70),

thereby alerting (26) upon cutting the physical attachment.

The second device (16) may include a transmitter (60), for alerting upon canceling the physically attachment of the second device (16) from the luggage (12).

At least one of the first (20) and second device (16) may include a transmitter (60), for finding the other device (16, 20),

thereby accompanying the owner (22) in finding the luggage (12) thereof.

The physical attachment of the second device (16) to the luggage (12) may include means for disallowing unnoticeable attaching of second device (16) to another luggage, e.g., strap 14 cannot be opened and the closed again.

The physical attachment of the second device (16) to the luggage (12) may include means for disallowing unnoticeable opening of the luggage (12), e.g., strap 14 closes the cover of the luggage, and must be torn for opening the cover.

In another aspect, the invention is directed to a method for protecting a luggage (12), the method including the steps of:
providing a first device (20) including a first code (56A) to an owner (22) of the luggage (12);
physically attaching a second device (16) to the luggage (12), the second device (16) including a second code (56B) being compatible with the first code (56A); and
allowing taking the luggage (12) out of a physical site (38),

upon verifying proximity of the first (20) and second (16) devices, and

upon verifying the compatibility of the codes (56A, 56B),

thereby requiring proximity of the luggage (12) to the owner (22) for the taking luggage (12) out of the physical site (38).

The method may further include the step of:
alerting (26) upon removal of the second device (16) from the luggage (12).

The method may further include the step of:
transmitting by the second device (16) location thereof.

The method may further include the step of:
attracting at least one camera (54A) of the airport to the second device (16) upon removal of the second device (16) from the luggage (12).

In the figures and/or description herein, the following reference numerals (Reference Signs List) have been mentioned:
numeral 10 denotes the system for protecting the luggage, according to one embodiment of the invention;
numeral 12 denotes the luggage;
numeral 14 denotes a strap for attaching the device to the luggage;
numeral 16 denotes the device being attached to the luggage;
numeral 18 denotes a signal;
numeral 20 denotes the device for being carried by the owner of the luggage;
numeral 22 denotes the luggage owner;
numeral 24 denotes scissors for removing the device from the luggage; the removal is allowed only after leaving the airport;
numeral 26 denotes an alert, such as vocal, and/or by RF transmittal;
numeral 28 denotes a server for receiving the alert from the device which should be attached to the luggage; the server may execute various means for catching the forbidden event of cutting the strap within the airport area;
numeral 30A, 30B and 30C denote detectors of the airport equipment, being a part of the inventive system;
numeral 32 denotes a speaker;
numeral 34 denotes a sounding applied by a speaker;
numeral 36 denotes a door of the airport, for being openable by the inventive system;
numeral 38 denotes the airport or another physical site;
numeral 50 denotes a table, including the conditions for allowing taking the luggage out of the airport;
numerals 54A and 54B denote cameras of the airport;
numerals 56A and 56B denote codes of the devices, being compatible, such as equal, with one another;
numeral 58 denotes the kit provided to the luggage owner;
numeral 60 denotes a transmitter;
numeral 62 denotes a battery;
numeral 66 denotes an alerting circuit;
numeral 68 denotes a circuitry;
numeral 70 denotes an electric wire; and
numeral 72 denotes an arrow.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A system for protecting a luggage, comprising:
a first device, for being carried by an owner of the luggage, said first device comprising a first code;
a second device, for being physically attached to the luggage, said second device comprising a second code being compatible with said first code; and
a detector, for allowing taking the luggage out of a physical site,
upon verifying proximity of said first and second devices, and
upon verifying said compatibility of said codes,
thereby requiring proximity of the luggage to the owner for said taking luggage out of the physical site.

2. A system according to claim 1, further comprising:
a strap,
for making said physical attachment of said second device to the luggage, and
for constructing an electric connection upon said physical attachment, for inducing said second device to alert upon cutting said electric connection,
thereby alerting upon cutting said physical attachment.

3. A system according to claim 1, wherein said second device comprises a transmitter, for alerting upon canceling said physically attachment of said second device from the luggage.

4. A system according to claim 1, wherein at least one of said first and second device comprises a transmitter, for finding the other device, thereby accompanying the owner in finding the luggage thereof.

5. A system according to claim 1, wherein said physical attachment of said second device to the luggage comprises means for disallowing unnoticeable attaching of second device to another luggage.

6. A system according to claim 1, wherein said physical attachment of said second device to the luggage comprises means for disallowing unnoticeable opening of the luggage.

7. A method for protecting a luggage, the method comprising the steps of:
providing a first device comprising a first code to an owner of the luggage;
physically attaching a second device to the luggage, said second device comprising a second code being compatible with said first code; and
allowing taking the luggage out of a physical site,
upon verifying proximity of said first and second devices, and
upon verifying said compatibility of said codes,
thereby requiring proximity of the luggage to the owner for said taking luggage out of the physical site.

8. A method according to claim 7, further comprising the step of alerting upon removal of said second device from the luggage.

9. A method according to claim 7, further comprising the step of transmitting by said second device location thereof.

10. A method according to claim 7, further comprising the step of attracting at least one camera to said second device upon removal of said second device from the luggage.
